(19) United States
(12) Patent Application Publication
(10) Pub. No.: US 2010/0288516 A1
(43) Pub. Date: Nov. 18, 2010

(54) FLUID EJECTION DEVICE

(75) Inventors: Christian FABRE, Tournnefeuille (FR); Alain BIGNOLAIS, Leguevin (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 12/483,402

(22) Filed: Jun. 12, 2009

(30) Foreign Application Priority Data
May 14, 2009 (FR) 09 53187

(51) Int. Cl. A62C 35/68

(52) U.S. Cl. 169/16

(57) ABSTRACT

The disclosed embodiments relate to a pressurised fluid ejection device. More especially, the disclosed embodiments relate to such a device especially intended for fire fighting with improved reliability and efficiency, especially concerning the device placing the tank in communication with the fluid distribution circuit, including: a tank containing fluid, a fluid ejection port, ejection port closing means, a device capable of opening the said closing means including a breakable seal and means capable of retaining the seal after breakage comprising a pivot with an axis perpendicular to the ejected fluid flow.

### CROSS-REFERENCE TO RELATED APPLICATIONS

This application claims priority to French Application No. 09 53187, filed on 14 May 2009, the disclosure of which is incorporated herein by reference in its entirety.

### BACKGROUND

1. Field

The disclosed embodiments relate to a pressurised fluid ejection device. More especially, the disclosed embodiments relate to such a device especially intended for fire fighting.

Pressurised fluid ejection devices such as extinguishers for fire fighting are placed in two categories:

devices under permanent pressure in which a gas ensures the permanent pressurisation of a fluid within a unique cylinder acting as tank,

devices under non-permanent pressure in which the fluid contained in the tank is pressurised only at time of its ejection: this pressurisation can be ensured by placing the tank containing the fluid in communication with a compressed gas source or by mechanical means such as the movement of a piston tending to reduce the volume occupied by the fluid in the tank.

2. Brief Description of Related Developments

In both cases, the ejection of the fluid implies that the fluid under pressure, contained in the tank, is placed in communication with a distribution circuit. This placing into communication can be done by the interposition between the outlet of the tank and the distribution circuit of a valve the opening of which is ensured by an outside control. Such devices can however remain inactive for long times (several years) whilst being submitted to severe environmental conditions such as humidity, frost and high thermal amplitudes. Consequently the valve systems, which imply the presence of moving parts and sealing constraints between the parts in relative movement, do not, in general, offer sufficient reliability to guarantee when the time comes the operation of the device. They therefore require a high inspection frequency especially if the fluid ejection device is essential to a safety device such as a fire fighting system. These frequent inspections have a direct influence on the maintenance cost of such devices.

To simplify the device and make it reliable, it is known, for example from patent EP1552859 or patent application US2005/150663 in the name of the inventor of the disclosed embodiments, to use a seal in the form of a membrane closing the tank and isolating it from the distribution circuit. To trigger the ejection of the fluid, the membrane is broken for a determined pressure level. This specific pressure level is reached, for permanent pressurisation devices, by the activation of a discerningly placed pyrotechnical detonator in such a way that the shock wave resulting from its activation tears or breaks the seal. For non-permanent pressurisation devices, the seal is advantageously broken when the pressure of the fluid contained in the tank reaches a suitable level for its ejection according to the targeted application.

In both cases, the debris from the seal must be collected after its breakage to avoid it from obstructing certain sensitive elements of the distribution circuit especially when the ejected fluid is intended to be sprayed and must therefore pass through nozzles with small section passageways.

For this purpose, it is known to install a screen, just downstream of the reservoir outlet port, the meshes of which are finer as the debris generated by the breaking of the seal is smaller. Such a screen comprises an obstacle disturbing the flow of the fluid and generating a load loss penalising for the efficiency of the fluid ejection device.

There exists therefore a need for a fluid ejection device with improved reliability and efficiency especially concerning the device placing the tank in communication with the distribution circuit.

To meet this need, the disclosed embodiments propose a fluid ejection device including:

a tank containing fluid,

a fluid ejection port,

ejection port closing means,

a device capable of opening the said closing means including a breakable seal and

means capable of retaining the seal after breakage comprising a pivot with an axis perpendicular to the ejected fluid flow.

As the means forming the pivot have an axis perpendicular to the ejected flow, the broken part of the seal aligns naturally with the flow so as to minimise the load losses. Advantageously, the axis of the pivot is off-centred in relation to the central axis of the fluid ejection port. Thus the broken section of the seal retracts almost completely and disturbs even less the ejected fluid flow. According to an advantageous embodiment, the seal includes a weakened zone on a section at least on its periphery. This breakage initiation zone will favour the cutting of the seal into a single piece and thus avoid the forming of multiple debris more difficult to retain.

Advantageously, the pivot can be made by the deformation of a connecting part. This embodiment allows the number of moving parts to be limited. In this case, the pivot can consist of an unweakened zone of the seal and the pivoting achieved by the deformation by bending of the membrane around this unweakened zone.

Advantageously, the fluid ejection port of the device according to the disclosed embodiments have a more or less rectangular section. This shape facilitates the pivoting of the broken section of the seal located in the flow and especially allows a rigid foil a zone of which has been weakened to be used as closing means. Such a foil is capable of breaking in an almost instantaneous manner under the effect of a pressure threshold thus favouring rapid ejection of the fluid whereas a more flexible membrane is liable to break in an incomplete manner then causing load losses during the ejection of the fluid.

Advantageously, the weakened zone, capable of favouring the breakage of the seal extends over the complete periphery of the seal. This configuration favours pure shear breakage of the seal under the effect of the pressure threshold and therefore favours the retraction of the seal after breakage and the absence of debris.

### SUMMARY

According to this embodiment, it is preferable that the axle of the pivot be connected to the seal and that it has, among other things, the possibility of translating in a plane more or less parallel to the ejection flow. Thus, the seal is broken by shear in a translation movement, then the broken section retracts by rotation around the pivot. Advantageously, the translation guide means can be extended in an oblique direction in relation to the flow so that the broken section of the seal is retracted to against one of the walls of the ejection port thus minimising the load losses.

According to a particular embodiment, the broken section of the seal located in the ejection flow has a profile favouring its retraction by rotation and/or by translation by hydrodynamic effect. This thus avoids this section of the seal, once retracted, from returning to its position under the effect of its own weight or prevents it from flapping in the fluid ejection flow.

The device according to the disclosed embodiments, which includes few moving parts liable to seize, is especially reliable and can advantageously be used as safety device on an aircraft.

### BRIEF DESCRIPTION OF THE DRAWINGS

The disclosed embodiments will now be more accurately described within the scope of the preferred embodiments, which are in no way limitative, shown on FIGS. 1 to 10 where:

FIG. 1 represents a cross-sectional view of the fluid ejection device according to the disclosed embodiments.

FIG. 2 represents, according to the same cross-sectional view, a detailed view of the ejection port during various seal breakage and fluid ejection phases according to a first embodiment. FIG. 2A before the triggering of the fluid ejection, FIG. 2B at the time immediately following the triggering of the ejection and FIG. 2C during the ejection of the fluid

FIG. 3 represents a cross-sectional front view of a particular embodiment of the seal using a composite material composition for the said seal.

FIG. 4 represents a cross-sectional front view of the various embodiment variants (FIGS. 4A to 4C) of a seal corresponding to a second embodiment where the axle of the pivot is made by the structure of the membrane comprising the seal.

FIG. 5 shows the behaviour of the seal according to this second embodiment before triggering of the ejection (FIG. 5A) and during the ejection of the fluid (FIG. 5B).

FIG. 6 shows a perspective and exploded view of the assembly of a seal according to a third embodiment.

FIG. 7 shows the behaviour of the seal according to this third embodiment during the various fluid ejection phases according to this third embodiment.

FIG. 8 represents in retracted position the broken section of the seal on a cross-sectional and perspective view according to a particular embodiment of the axle guide slots.

FIG. 9 shows a particular embodiment of the profile of the broken section of the seal located in the flow favouring the retraction of the broken section.

FIG. 10 shows a cross-sectional and perspective view of a fourth embodiment where the pivot is made by a deformable link, in closed position (10A) and in open position (10B) of the seal.

### DETAILED DESCRIPTION OF THE DISCLOSED EMBODIMENTS

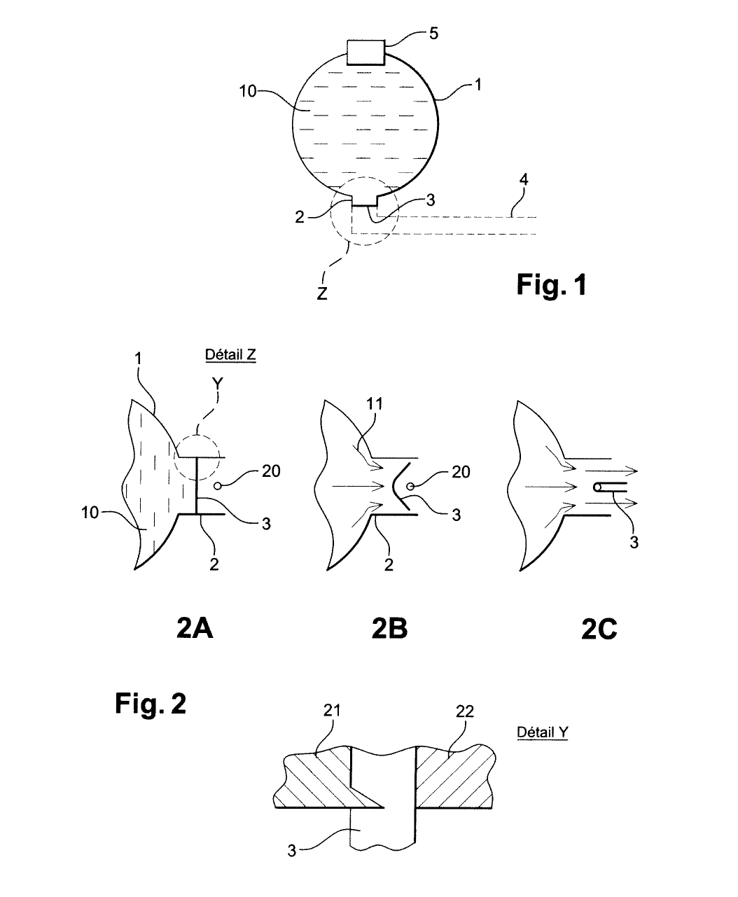

FIG. 1, a fluid ejection device includes:

a tank (1),

this tank is at least partially filled with a fluid (10),

an ejection port (2),

connected to a distribution circuit (4),

means (5) to generate a pressure in the tank,

and a seal (3) to isolate the content of the tank from the distribution circuit.

Those skilled in the art know various embodiments of these fluid ejection devices. These are described especially in patent applications FR2922972 and WO2006061539 in the name of the inventor of the disclosed embodiments. The fluid (10) can be stored in the tank under permanent pressure and, in this case, the tank pressurisation means will be absent or will be simply intended to generate a shock wave capable of breaking the seal (3). The tank may be filled only partially with the fluid to be ejected, thus defining two chambers, which can be separated by a separation element such as a membrane. The tank can be of any shape adapted to the targeted use. It can especially be of cylindrical form and include two chambers, one of which contains the fluid, separated by a piston. The type of fluid can vary, it can especially be a fluid capable of fire fighting, such as a fluoroketone like Novec 1230® marketed by 3M. It can also be a hydraulic oil.

FIG. 2A, the seal (3) isolates the inside of the tank from the distribution circuit. Advantageously, it is in the form of a membrane, of section equivalent to the inside section of the ejection port, so as to close the passageway, the said membrane is connected at its periphery to the said ejection port (2). Advantageously, an axle (20), perpendicular to the ejection flow is placed downstream of the said membrane (3). To trigger the ejection of the fluid, the pressure is increased inside the tank by appropriate means, for example by a pyrotechnical gas generator. The membrane (3) is breakable, that is when the pressure reaches a defined threshold, FIG. 2B, the periphery of the membrane breaks thus freeing the passageway and enabling the ejection of the fluid into the distribution circuit. Once broken, the membrane, deformed and driven by the flow of the fluid winds around the axle (20), FIG. 2C, which then acts as a pivot and allows the said membrane (3), bent around this axle, to align with the ejection flow (11) according to an orientation limiting the load losses.

This embodiment is very simple but requires tests for fine tuning. Indeed, it must be ensured that the breakage occurs at the periphery and not in the centre of the membrane. This can be obtained, for example, by gripping the periphery of the membrane between two parts (21, 22) one of which (21) has a contact face capable of initiating breakage (detail Y on FIG. 2) at the periphery of the membrane acting as seal. Alternatively, it is possible, during installation to make a scratch on the periphery of the disc with a tool such as a scriber.

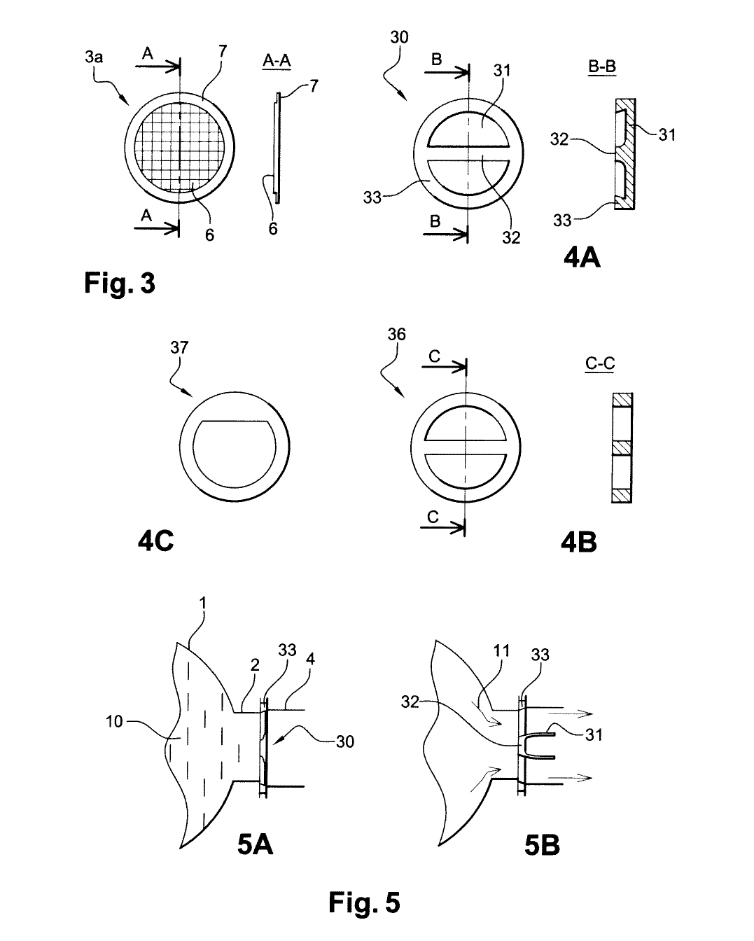

Also, the axle (20) must be placed at a sufficient distance from the membrane which, seen from the tank, deforms in a concave manner under the effect of the pressure while it is not yet broken, then in a convex manner under the effect of the flow, which allows it to be captured by the axle (20). The distance must therefore be sufficient to allow the inversion of the curvature of the broken section of the seal but this without this part having the time to speed up in the flow. The diameter of the axle (20) must also be sufficient so that the broken section of the seal is effectively stopped by the axle without it being able to avoid it by simply tipping over, but remain sufficiently small so as not to disturb the flow to too great an extent. This embodiment is more easily fine tuned using a seal (3a) consisting of a fibre-reinforced composite material, FIG. 3. According to this embodiment, the seal (3a) includes two zones:

a central zone (6) reinforced by filaments or a glass, steel or polyamide fabric or any other fibre in an elastomer matrix

a peripheral zone (7) also consisting of an elastomer but without reinforcement

As the peripheral zone (7) is not reinforced, it preferably fails when the pressure applied to the membrane (3) reaches a critical threshold. The presence of a fabric in the central zone (6) prevents it from breaking up to form debris whilst providing it with sufficient flexibility to inverse its curvature over a short distance and wind around the axle (20).

It is however more advantageous, in terms of fine tuning and operating reliability, to integrate the pivot into the structure of the seal itself.

According to this second embodiment, FIG. 4A, the seal (30) includes a peripheral zone of higher thickness (33) and a central reinforced zone (32). A section with lower thickness (31) extends between these two reinforced zones.

Advantageously, the junction between the peripheral reinforced zone (33) and the thin section (31) has a profile capable of favouring breakage initiations on its periphery whereas the junction between the central reinforced zone (32) and the thin section (31) has on the contrary a profile limiting the stress concentrations. The junction of the central section (31) of the seal with its peripheral zone (33) comprises therefore a weakened zone capable of favouring and initiating the breakage of the seal.

FIG. 5A, the seal (30) is installed between the ejection port (2) and the end of the distribution circuit by gripping its reinforced peripheral zone (33) between two flanges. The peripheral ends of the central reinforced section (32) are also gripped between these two flanges. When triggering the ejection of the fluid, when the pressure threshold is reached, the thin section (31) breaks away from the peripheral zone (33), but not from the central reinforced section (32), for which the transition of the section is more tapered. FIG. 5B, under the effect of the ejection flow, the thin sections (31) bend along their junction with the central reinforced section and are oriented more or less parallel to the flow.

This embodiment is more reliable but the manufacture of the seals (30) is more complex to do economically for small series. Alternatively, FIG. 4B, a similar result can be obtained by using a composite seal. In this case, a part (36) corresponding to the contour of the peripheral section (33) and the central reinforced zone (32) is punched out from a metallic foil. Then a composite seal (3a) the structure of which, partially reinforced by the fibres, is equivalent to that of the corresponding variant of the first embodiment is added to this part (36), for example by bonding. When the pressure reaches a critical threshold, the central composite section (6) fails at the periphery but remains held by the foil (36) in the central zone, foil which is in this case dimensioned so as not to fail under the effect of the pressure.

According to this embodiment of the seal (30), it is also possible to use a reinforcement foil (37) the form of which allows a pivot to be made in an off-centred manner. Under these conditions, the broken section of the membrane is sufficiently flexible to retract against the distribution circuit inlet wall thus minimising the load losses.

This embodiment is even more reliable than the first one, nevertheless, the peripheral breakage mode is such that under certain circumstances, the said peripheral breakage is not complete and a section of the seal, still held over a limited length of its periphery can cause a load loss in the flow of the fluid.

Indeed, as the seal is flexible, it deforms before breaking like a membrane under the effect of the pressure taking a concave form seen from the tank. The breakage is initiated in tension on a point of the periphery then propagates by tearing according to an opening mode in torsion between the edges of the said tear. It can happen that the force applied by the fluid ejection flow leads to the bending of the section of the seal separated from its peripheral attachment instead of propagating its tear along the complete perimeter. To avoid this type of behaviour, it is preferable to completely break the seal without propagation of the tear according to the pure shear breakage mode.

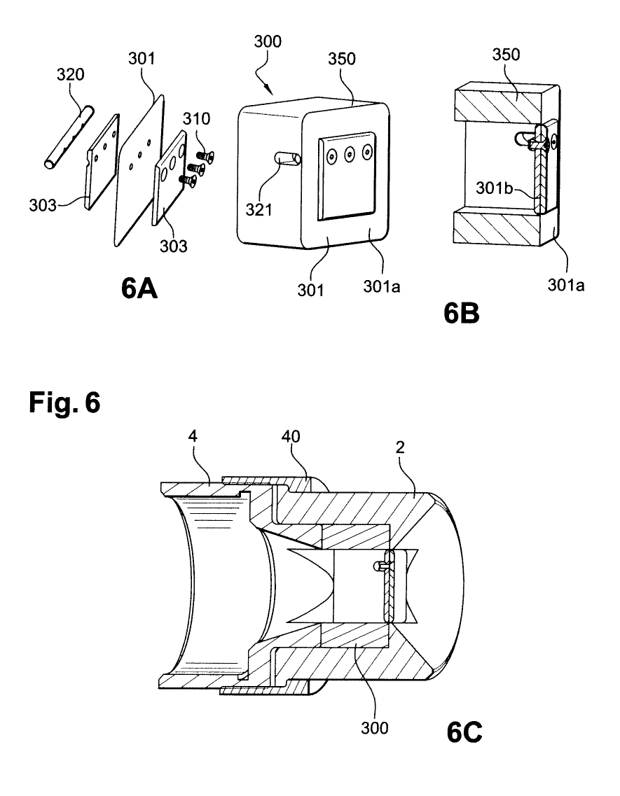

According to a third embodiment, FIG. 6, the seal (300) consists of an assembly of items including:

a foil sheet (301), preferably metallic and of a section sufficient to cover the complete tank port,

the said sheet is gripped, in its central section (301b), between two flanges (303) by means of screws (310) passing through the two flanges and the said sheet,

the said screws (310) are screwed transversally into an axle (320) longer than the width of the flanges which is thus solidly attached to the flanges and to the foil sheet.

The assembly consisting of the flanges (303), the axle (320) and the foil (301) thus assembled, is installed in a yoke (350) including a conduit the section of which has a form adapted to fit around the flanges (303) with a slight peripheral clearance. The yoke (350) includes two slots (321) capable of accommodating the two ends of the axle (320). For this purpose, the yoke can be made in two parts, or alternatively, the axle (320) can be initially slid through the two slots (321) of the yoke (350), the flanges (303) and the foil (301) then being assembled on the axle by means of screws (310). Those skilled in the art will easily adapt any other assembly method. FIG. 6C, the assembly thus assembled is gripped between the port (2) of the tank and the end of the distribution circuit (4), connected together by a union (40). Advantageously, according to this embodiment, the flanges (303) ensure protection of the foil (301) any possible small shocks liable to occur during the installation of the fluid ejection device on the distribution network. The central section (301b) of the foil is reinforced by the flanges (303) whereas the outer section of the foil (301a) is gripped between the yoke (350) and the inlet end of the distribution circuit (4). The peripheral zone of the foil between the flanges and the clamped outer section (301) therefore comprises a weakened zone liable to initiate the breakage of the foil.

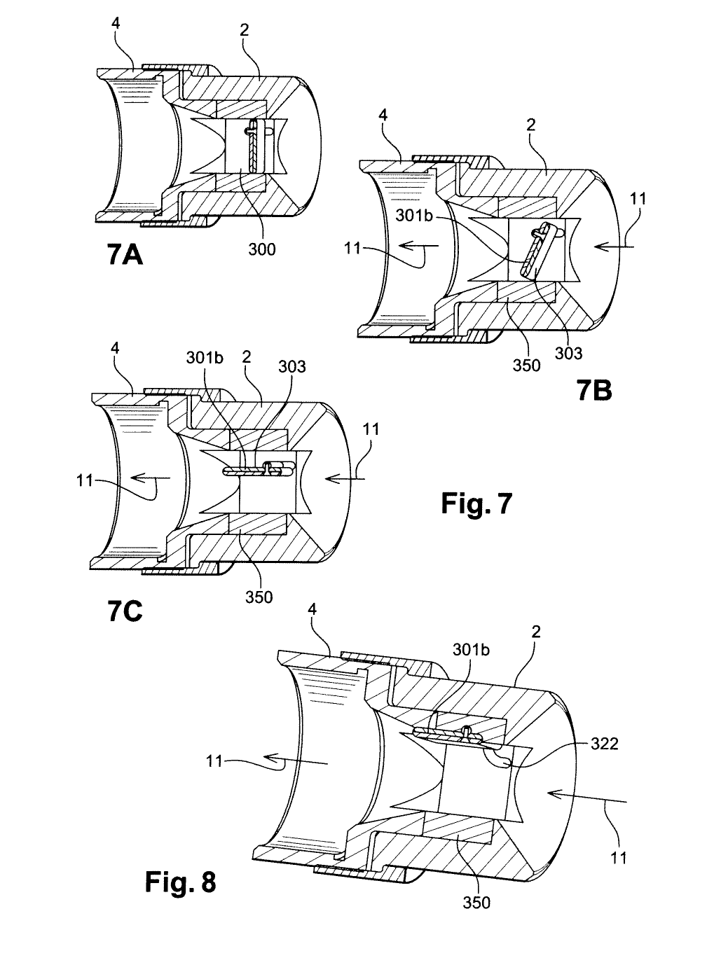

FIG. 7A, when the pressure in the tank (1) reaches a defined threshold, the contour of the foil (301) which is gripped between the yoke and the end of the port (2) breaks by pure shear, the section of the foil (301b) gripped between the flanges (303) moves in translation guided by the axle in the oblong slots (321). The section gripped in the flanges is then free to rotate, FIG. 7B, and the flow of the fluid (11) tends to retract it by pivoting around the axle (320). For a more efficient retraction, it is preferable that the axle of the pivot be off-centred, so that the broken section is more or less forced against the walls of the conduit. However, the stiffness of the flanges (303) does not allow them to adapt to the variations in the width of the conduit during such an off-centred rotation so that, in this embodiment, the section of the seal is advantageously rectangular and preferably square.

FIG. 7C, rapidly, the broken section of the seal is retracted under the effect of the flow of the fluid. FIG. 8, to favour this retraction, the oblong slots (322) can, according to a particular embodiment, include an inclined portion so that the broken section of the seal will approach the walls of the conduit once it is oriented parallel to the flow.

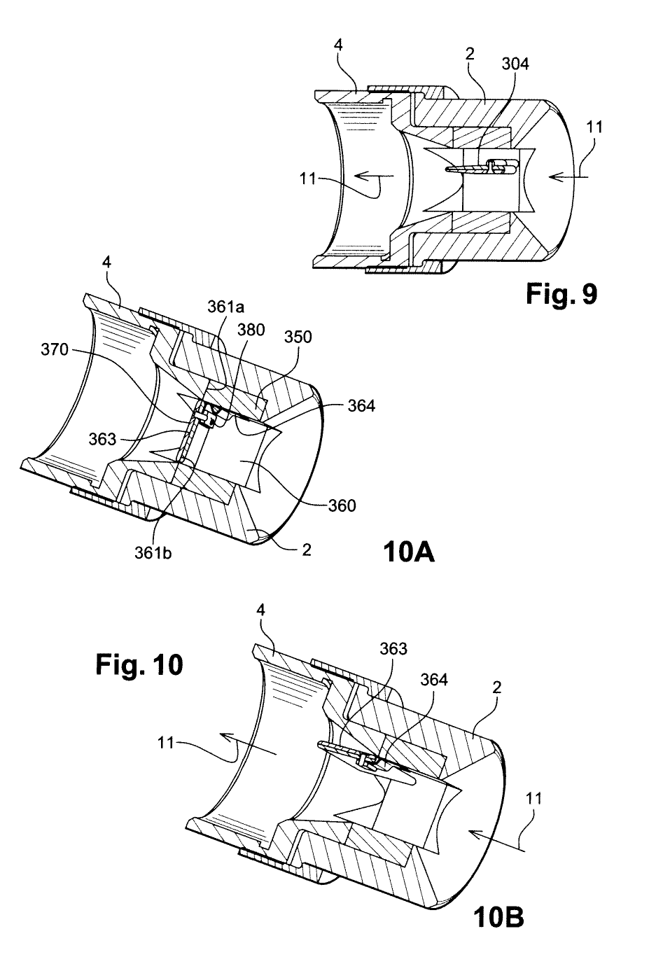

FIG. 9, to maintain the broken section of the seal in its retracted position, it has a specific profile (304) giving it a hydrodynamic lift when it is placed in the flow. This profile is obtained by the use of adapted flanges (304).

FIG. 10, according to a fourth embodiment, the seal (360) consists of an assembly of items including:

a foil sheet (361), preferably metallic and of section sufficient to cover the complete tank port,

the said sheet is gripped, in its central section, between two flanges (363) by means of screws (370) passing through the two flanges and the said sheet,

the said screws (370) are screwed transversally into an end element (380) of a deformable link (364) itself connected to a yoke (350).

The assembly thus assembled is held between the port of the tank and the distribution circuit as according to the third embodiment. The central section (361b) of the foil is reinforced by the flanges (363) whereas the outer section of the foil (361a) is gripped between the yoke (350) and the inlet end of the distribution circuit (4). The peripheral zone of the foil (361) between the flanges and the clamped outer section (361a) therefore comprises a weakened zone liable to initiate the breakage of the foil (361).

FIG. 10A, the deformable link (364) is advantageously preformed to favour the displacement of the foil and flange assembly (361b, 363) according to two sequential modes.

The presence of the rigid flanges (363) extending over the opening surface of the yoke (350), in addition to protecting the foil (361) according to the third embodiment, ensures its breakage by pure shear. Thus, when the pressure in the tank reaches a critical value, the seal breaks by pure shear. This deformation mode is favoured by the performing of the link (364) which, according to a first deformation mode, favours a displacement parallel to the flow (11) during its unfolding, the broken section of the seal being moreover guided at the periphery by the opening section of the yoke.

FIG. 10B, when the link (361) is unfolded, the broken section of the seal enters into a zone where the opening section is higher, at the inlet of the distribution circuit (4). The broken section is then no longer guided in translation and can retract, by bending of the end of the link (364) under the effect of the flow (11). Those skilled in the art will understand that, according to this embodiment, the opening section of the yoke is not necessarily rectangular, the retraction of the broken section of the seal occurring outside of this section downstream in the flow direction.

The description above clearly illustrates that by its various characteristics and their advantages, the present disclosed embodiments attain the objectives which were fixed. Especially, it improves the reliability of the placing in communication of the fluid ejection device with the distribution circuit by limiting the number of the moving parts whilst avoiding the forming of debris and without creating excessive load losses. The fluid ejection device according to the disclosed embodiments are suitable to all types of fluids whether these be in a gaseous, liquid or diphasic form in the form of an aerosol, a suspension or an emulsion. It is however more especially advantageous when ejected fluid has a high density or viscosity and it is ejected at a high flow rate. Indeed, in this case, the load losses related to the presence of obstacles in the flow are especially high.

What is claimed is:

1. Fluid ejection device characterised in that it includes:
a tank (1) containing the fluid (10)
a fluid ejection port (2)
closing means (3) for the ejection port including a breakable seal (3, 3a, 30, 300)
a device capable of causing the opening of the closing means (5)
means (20, 32, 37, 320, 364) for retaining the broken section (31, 301b, 361b) of the seal after breakage forming a pivot with the said broken section, the axle of the said pivot being perpendicular to the ejection flow (11) of the fluid.

2. Device according to claim 1 characterised in that the seal includes a weakened zone (31, 7, 301a, 361a) capable of initiating the breakage of the said seal over at least a section of its periphery.

3. Device according to claim 2 characterised in that the pivot consists of a deformable link (32, 364).

4. Device according to claim 3 characterised in that the pivot consists of an unweakened zone (32) of the seal.

5. Device according to claim 3 characterised in that the axle of the pivot is off-centred in relation to the central axis of the fluid ejection port.

6. Device according to claim 1 characterised in that the seal includes a weakened zone over its complete periphery (7, 301a, 361a).

7. Device according to claim 6 characterised in that the fluid ejection port has a more or less rectangular section.

8. Device according to claim 7 characterised in that the axle of the pivot is attached to the seal and that it includes sliding guide means (321) of the said axle in a plane parallel to the ejection flow (11).

9. Device according to claim 8 characterised in that it includes sliding guide means (322) for the axle in an oblique plane with regard to the ejection flow.

10. Device according to claim 8 characterised in that the broken section of the seal located in the ejection flow has a profile (304) capable of favouring its retraction by hydrodynamic effect.

11. An aircraft characterised in that it includes a device according to claim 1.
